(19) United States
(12) Patent Application Publication
(10) Pub. No.: US 2019/0011255 A1
(43) Pub. Date: Jan. 10, 2019

(54) Method to Measure Road Surface Profile

(71) Applicant: Yaxiong Huang, Austin, TX (US)

(72) Inventor: Yaxiong Huang, Austin, TX (US)

(21) Appl. No.: 16/026,045

(22) Filed: Jul. 3, 2018

Related U.S. Application Data
(60) Provisional application No. 62/528,537, filed on Jul. 5, 2017.

(51) Int. Cl. G01B 21/30

(52) U.S. Cl. CPC G01B 21/30

(57) ABSTRACT

The present invention is an apparatus and method to measure surface profile at walking or traffic speed. The invention includes a multipoint or line style displacement sensor mounted on a moving platform, a distance measurement instrument, and a data processing unit with special designed moving reference algorithm. The displacement sensor samples multiple data points simultaneously from a line on the surface at a triggering distance or time. The distance measurement instrument presicely tracks the travel of the moving platform and produces trigger signal at given distance. The data processing unit uses moving refrence algorithm to remove sensor body movement caused by unwanted platform viberations, then the unit processes elevation data from the displacement sensor and calculate desired parameters at given distance. As the distance on the surface covered by each sample is much longer than the trigger distance, large percentages of two concecutive samples are overlapping; only a small portion of each sample is new compared to the previous sample. Because the overlapping portions of two consecutive sample are taken from the same surface location, they contain the same information of the surface. Differences between the overlapping portions of two concecutive samples are due to the vertical and tilting movements of the sensor body or the moving platform. By analyzing the overlapped portions of two consecutive samples, these differences can be qualtified and removed. Then the second or newly acquired sample can be aligned to the ground truth. The non-overlapping portion in this new sample, which covers the travel distance between trigger signals, is the true profile from the surface. A longer surface profile can be obtained by connecting true profiles at each trigger distance.

### TECHNICAL FIELD OF THE INVENTION

The present invention is in the technical field of surface profilometer for surface profile measurement. More particularly, the present invention is a method to collect surface true profile at walking speed or in high speed operation. Examples presented in this application are for longitudinal road profile, but the method is applicable to other type of surfaces.

### BACKGROUND OF THE INVENTION

A road profiler or profilometer is an instrument widely used to measure road surface profile along the travel direction. Data from a road profilometer, called longitudinal profile or simple profile, can be used to evaluate road surface condition, calculate international roughness index (IRI), and other road feature parameters.

To measure a road profile, three key ingredients are required and are combined by a profiler. 1) A reference elevation. 2) A height between the surface and the reference. 3) And longitudinal distance. In current practice, numerous devices are invented and used for road profiling. These devices mainly fall into two categories; a low speed walking profilometer and a vehicle mounted high speed profilometer.

A vehicle mounted high speed road profilometer uses the vehicle body as its reference. It uses a precise displacement sensor mounted on a vehicle body at or near the wheel path locations to measure the height relative to the reference, i.e. the road height changes relative to the vehicle body. And a distance measurement instrument (DMI), often a wheel encoder, to measure travel distance and speed. In an idea case, the reference maintains a constant altitude; measurements from the displacement sensor give true road surface elevation changes or the road profile. However, in reality, when vehicle moves, it can not maintain required constant reference altitude due to its vertical motion and vibrations. As the displacement sensor is mounted on the vehicle and moves with the vehicle, measurement from the displacement sensor is affected by the vehicle motions. These vehicle motions must be removed from the displacement sensor data to produce real road elevations or surface profiles. In current practice, an accelerometer mounted close to the displacement sensor is used to measure the vehicle vertical acceleration. Then the vehicle vertical motions can be calculated from the measured acceleration with twice mathematical integrations. The road profile then can be obtained by subtracting the vehicle motion from the displacement sensor data. Because this type profilometer uses an accelerometer to establish its inertial reference elevation, it is also called inertial profiler.

The main problem related to a high speed inertial profile is caused by the characteristics of the accelerometer. At low speed, its output signal related to the acceleration is too small to be distinguished from system electronic noises. If traveling through a road curve, centrifugal force applied on the accelerometer will produce false acceleration signal. Pavement surface slope, i.e. the cross slope in transverse direction and grade in travel direction, will also cause errors in the output of the accelerometer. When the vehicle is tilted, the accelerometer can not provide accurate vertical vehicle accelaeration. In current practices, applications of a high speed inertial profilers are limited to travel speed above 15 mph to reduce the low speed noise problem. However, acceleration errors due to road slope remain in the profile data. In addition, vehicle vertical motion calculated from twice intergration of the accelerometer signal drifts over the travel distance. In practice, a 250 feet highpass filter is used to eliminate data drift longer than 250 feet. This method reduce the problem from the twice integration, but also removes all road features longer than 250 feet.

A walking protilermeter or profiler is a low speed instrument, usually takes measurement of surface profile at few miles per hour speed. There are different type of walking profilers currently in use. These instruments designed with different principles and can be used to measure road IRI. Some existing walking profiler, such as the dip stick, can measure the surface true profile, but it is very slow and gives no detailed surface feature.

This invention presents a surface profilermeter based on a new moving reference method. It can measure surface true profile and IRI in a full speed range. It is also capable of providing detailed surface features.

### SUMMARY OF THE INVENTION

The present invention is a method and apparatus using a multipoint or line style displacement sensor to measure surface profile from a moving platform. The sensor covers a segment of the surface and samples a multipoint data array simultaneously at a given trigger distance. The given trigger distance is controlled by a DMI in form of trigger signals along the travel direction. In this invention, the length of the surface segment covered by the line displacement sensor is much larger than the trigger distance between samples. Surface profiles sampled consecutively are partially overlapped. In any given sample array, only a small portion of data at the end of the array in travel direction is new, the rest data in the array are measured from the same surface segment partially covered by the previous sample.

In present invention, the displacement sensor measures relative distances between the surface and the sensor mounting frame, i.e. a vehicle body in case of a road profiler. The sensor mounting frame serves as the height reference. Surface profiles can be obtained from the displacement sensor data relatively to the reference. However, during measurement, when the sensor mounting frame moves on the surface, for example, the vehicle travels on road surface at high speed, the height reference will drift due to the vehicle vertical motion on road surface and vibration. This reference drif must be corrected or removed to restore accuracy of the reference and the measured surface profile.

Not like the traditional inertial profiler, which uses an accelerometer to measure sensor mounting frame motion and establish a inertial height reference, the present invention designed with a special designed moving reference method to calculate and remove the mounting frame motions. As previously discussed, a large portions of two consecutive sample data arrays are overlapped to each other. These overlapped portions are measured from the same surface segment. They contain the same surface profile information. If the reference, i.e. the vehicle body drifted between two sampling times, these two portions will be separated. The value of this separation can be calculated and then removed with the moving reference method.

As all data points in a given sample are captured at the same time from a single sensor, all data points in this sample experience the same body viberation, the reference drift calculated by the removing reference process can be used to remove errors caused by the viberation from all data points. After this processing, the entire sample array is related to a fixed height reference and is the true surface profile. Each sample only contributes a small portion to the entire profile data. The length of that portion is equal to the trigger distance. Repeat the same processing for every trigger distance of travel, a continuous surface profile can be produced. In this invention, because the height reference is established by analyzing the difference between two concecutive samples, i.e. using previouse sample to pass the height reference to current measurement, a surface profiler based on this principle can be called a moving reference profiler.

Comparing present invention to a traditional inertial profiler, a moving reference profiler does not use an accelerometer to establish an inertial reference. Therefore, the travel speed and orientation changes will not affect the accuracy of the moving reference calculation. A profiler implemented with present invention may run over the full speed range, from low speed walking to high speed vehicle mount applications.

### BRIEF DESCRIPTION OF THE DRAWINGS

For a more complete understanding of the features and advantages of the present invention, reference is now made to the detailed description of the invention along with the accompanying figures and in which:

FIG. 1 illustrates an example of the system hardware setup. In which, the system is mounted on a vehicular moving platform. When the vehicle moves on a surface in a given travel direction, the DMI encoder attached to a wheel sends out electronic pulses to trigger the displacement sensor at every fixed travel distance. The displacement sensor is a multiple point, or line style sensor, which covers a segment of surface with length of L. Every time, when triggered, the sensor takes N points distance data of between the surface and the sensor reference, and sends them to the onboard computer. Then the onboard computer processes each sample data with the moving reference algorithm to get true surface profile.

FIG. 2 illustrates an electronic and electrical connection diagram of the apparatus in FIG. 1. The power source provides required power to all devices and components. The DMI encoder generates pulse signals to trigger the displacement sensor at given travel distance. The displacement sensor samples an array of data when triggered and sends the sampled data to processing unit via a connection. Then the processing unit, a computer for example, processes sample data with the moving reference algorithm for road surface profile.

FIG.3 illustrates two triggering positions during measurement. Two surface segments are sampled at position #1 and position #2 when the device moves over the surface. Considering the vertical bouncing and tilting of the mounting platform, the vehicle body in this example, the sensor body may be in the differenct positions regarding to the vertical reference, causing errors in each, sample of surface profile data. These errors can be quantified by analyzing the overlapped portions of sample data and removed later.

FIG. 4 displays two consecutive profile samples. Sample #2 was taken at a trigger distance away from the sample #1 position. In Sample#2, each data point is moved by a trigger distance in the direction opposite to the travel, compared to the corresponding data point in Sample#1 collected from the same surface location. As each of these two profile samples covers a surface segment much longer than a trigger distance, large portions of these two samples were taken from the same surface segment; these portions contain the same surface information statistically.

FIG. 5 illustrates the alignment process. With both sample arraies ploted at the same travel distance scale, move the second sample data array to the travel direction with a number of data points, which cover a surface segment equal to a triggering distance. Then, two sample arries are aligned along the travel direction, therefore the overlapped portions of the two sample arraies are from the surface segment. Differences or errors between two aligned data arrays are caused by platform motions other than the one in travel direction.

FIG. 6 Differences between two aligned data arrays can be analyzed with linear correlation or other mathematic or statistic methods. The analysis will produce an error function or a numerical error table. As the sample #1 is considered a corrected ground truth, this function or table are used to remove all errors caused by platform motions in sample #2. Since the entire sample #2 was captured by a single sensor at the same time, all data points experience the same motion errors. Therefore the error correction function of table are also appliable to the newly sampled surface segment. In fact, this aligned new segment is the effective data from second sample. It will be added to previous profile data to extend the measurement.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The terminology used and specific embodiments discussed herein are merely illustrative of specific ways to make and use the invention and do not delimit the scope of the invention.

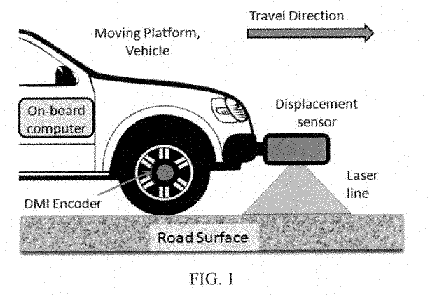

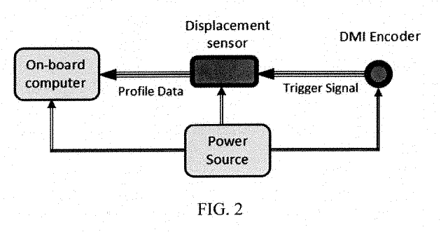

Referring now to the drawings, wherein like reference numerals designate corresponding parts throughout the several views, FIG. 1 shows side view of a possible setup of the surface profiler implemmeted with a line style displacement sensor, a distance measurement device, and a processing unit running a moving reference algorithm to correct platform motions other than the forward travel. FIG. 2 shows a possible electrical and signal connections between different components listed in FIG. 1. Giving as an example of possible implementations, the displacement sensor is a line style sensor based on so called laser triangulation principle. In a typical line style laser triangulation sensor, a laser line projector is used to produce a fine laser line beam on the surface at a given fan angle. A two dimensional photo detector array or a high resolution camera, positioned with and angle between the laser beam, detects the line of laser light reflected from the surface. When surface elevation changes, the laser line image in the photo detector array or the camera will change. A process then comverts this line image into related surface elevation change, or displacement. Depending on the size of the photo detector array or the camera, the sensor can take handreds or thounsands displacement data from covered surface segment in a single sample. In an out door application, a narrow band pass optical filter is used to block ambient light, only reflected laser can be received by the photo detectors.

To measure true surface profile, an elevation reference is required. The elevation reference should be available for every sample. The sample data are distance values between the elevation reference and the surface. In an idea case, the sensor mounting platform, or the sensor body should remain vertically unchanged. In other words, during the entire measurement, the sensor body should have only one linear motion along the travel direction and the sensor body keeps a constant elevation, therefore the sensor output data is the true profile of the surface. However, in case of a vehicle mounted profiler, the sensor body follows vehicle motions. Vehicle vertical bouncing and angular motion add errors to the elevation reference. These errors will pass to the surface profile data.

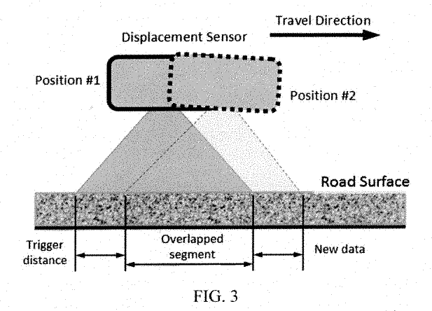

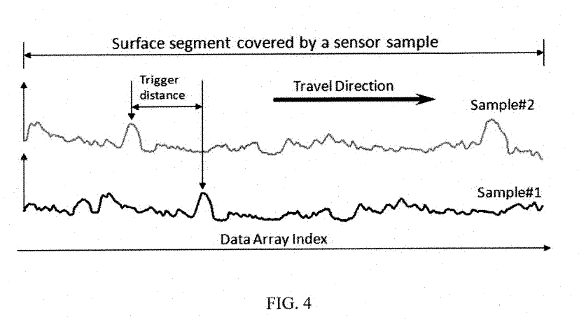

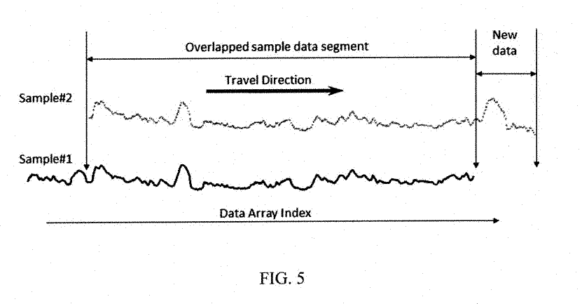

Errors caused by vehicle bouncing are random and differ from sample to sample. FIG. 3 shows two concecutive samples taken at position #1 and #2. Compared to sensor body at position #1, sensor body at position #2 may change its oritation and vertical position due to the vehicle bouncing. The changes will cause separation of two sampled data. FIG. 4 shows two concecutive samples saerated from each other. These two samples are taken at a travel distance equal to one trigger distance. Shift the second sample data array one trigger distance to the right, as shown in FIG. 5, center part of two sample data array can be aligned. In other words, corresponding data points in the center overlapped portions of two samples are from the same surface locations, they should have the same value of surface elevation. Analyzing the differences between points of the overlapped portion, a linear error function can be derived. Applying this function to and substracting values from the second sample will remove differences, caused by vehicle councing, from the entire sample data.

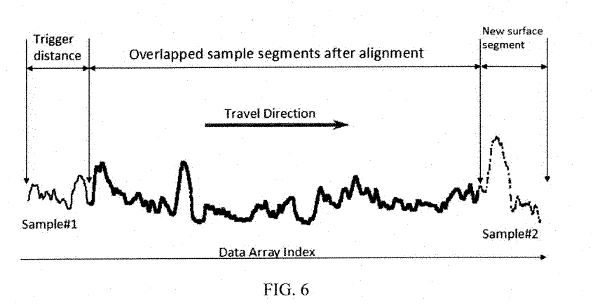

FIG. 6 shows the processed samples. After removing errors in second sample array, vehicle bouncings are revoved from the entire second sample data array. The vertical reference for the second sample are restored to the condition in that the first sample was taken. With the the same process applied to next concecutive sample pair of the second and third samples, a constant vertical reference established at the time of the first sample can be achived to future samples. This method uses the previous sample to establish vertical reference to the next sample, it is called moving reference method.

Each sample contribute a part of surface measurement to the surface profile. The length of the part equal to one trigger distance. With contiouse sampling, the entire true surface profile can be obtained.

1. An apparatus or a system for measuring road surface profile by using one or more line style displacement sensor(s) in the direction of travel; a distance measurement device or an alignment algorithm to control data acquisition at a given trigger distance or a given time interval; a data processing device analyzing difference between sampled line data arries to establish and maintain a constant vertical reference height, and accumulating processed segments of surface measurement to form a true surface profile along the treval direction, and calculating parameters related to the surface profile and roughness; and a display device to show result in both numerical and graphical formats. Differenct algorithm may used to analyzing samples to remove errors.

2. The system of claim 1, wherein the line style displacement sensor is a distance measurement device comprises multiple measurement data points along a line segment on the testing surface, it may use optical, ultra sound, or other physical prociple to acquire the distance between the sensor and the surface.

3. The system of claim 1, further comprising more than one sensors in the direction of travel. In this case, sample data from one sensor can be used as reference to sample data from next sensor.

4. The system of claim 1, more than one such a system can be used on the same moving platform to collect profile data for different wheel pathes on road surface.

5. The system of claim 1, wherein the sensor could be mounted on a fast moving vehicle, or on a slow moving manual or self-driven platform treval on the surface for data acquisition.

6. The system of claim 1, the line style displacement sensor could be a single line or a number of lines in parallel or in mixed orientations for data acquisition.

7. The system of claim 1, the distance measurement device can be replaced with a data processing algorithm which compares two sets of sampled data and calculates distance between the two sets of data, and further giving the moving speed and sample trigger distance.

8. A method of taking samples from the sensor in a shorter travel distance than the distance covered by the sensor data line on the surface. With this method, a large portion of a sampled data array is taken from a part of the surface segment sampled previously. Any two concecutive samples are partially overlapped. The overlapped portion is sample by both samples from the same surface segment.

9. The method of claim 6, further controlled either by trigger signals from a distance measurement device, or a mathmetical processing which calculates distance between samples from different sets of sample data.

10. A method of using the previous sampled data array from the line style sensor to establish a constant vertical reference for true surface profile measurement. The method analyzes two or more sample data arraies, using the difference between the two as a correction function. This function is the sensor body bouncing between samples. It can used to remove sensor body bouncing and restore the vertical reference.
